(19) United States
(12) Patent Application Publication
(10) Pub. No.: US 2005/0150082 A1
(43) Pub. Date: Jul. 14, 2005

(54) Removable mechanism for electronic devices

(76) Inventor: Shoei-Yuan Shih, Taipei Hsien (TW)

Correspondence Address: BIRCH STEWART KOLASCH & BIRCH, PO BOX 747, FALLS CHURCH, VA, 22040-0747, US

(21) Appl. No.: 10/755,467

(22) Filed: Jan. 13, 2004

(51) Int. Cl. E05B 1/00

(52) U.S. Cl. 16/422

(57) ABSTRACT

A loading cartridge latch structure located in a computer host to anchor a loading cartridge includes a passage and a latch trough that communicate with each other. The latch trough is larger than the latch section to form a latch position and a release position. On the latch position the handle is in a latched condition through an anchor structure to anchor the loading cartridge on an installation object. When the latch section is on the release position the handle is released from latched condition of the anchor structure and the handle is moved to a release angle to facilitate removing of the loading cartridge.

### FIELD OF THE INVENTION

The present invention relates to a loading cartridge latch structure and particularly to a latch structure for stacked loading cartridges to facilitate loading and unloading.

### BACKGROUND OF THE INVENTION

The conventional method for anchoring a loading cartridge 20 used in electronic devices (such as hard disk) on a computer host 10, referring to FIG. 1, generally is through a handle 21 located on the front end of the loading cartridge 20. The handle 21 has latch sections 23a on two sides and an anchor structure 22. The computer host 10 has partitions 11 to define installation space for the loading cartridge 20. The partition 11 has a latch notch 11a to mate the latch section 23a of the loading cartridge 20 to form coupling required. Referring to FIG. 2, when the loading cartridge 20 and the computer host 10 are coupled, the anchor structure 22 is at a latched condition to anchor the loading cartridge 20, and the handle 21 is slightly close to the coupling face of the computer host 10, and the latch section 23a is housed in the latch notch 11a. The latch notch 11a has a retaining flange 11b at the front end to confine the loading cartridge 20 in the latched condition of the anchor structure 22 without moving horizontally and slipping out of the computer host 10. However such a design still has problems, notably:

1. The retaining flange 11b confines the latch section 23a in the vertical direction. In the event that the computer host 10 has abnormal vibration, the latch section 23a might move downwards and release the latched condition, and the loading cartridge 20 could slip out of the computer host 10.

2. When users want to unload the loading cartridge 20 and release the latched condition of the anchor structure 22, as the latch section 23a is completely held in the latch notch 11a, there is no enough space for the handle 21 to tilt a desired angle. User has to operate with two hands to depress the anchor structure 22 and pry the handle 21 upwards (shown by the arrow direction) to disengage the latch section 23a from the latch notch 11a and remove the loading cartridge 20. While it may be workable for a single layer loading cartridge 20, but in the occasion in which a plurality of disk drives stacked in an array fashion in the computer host 10, the loading cartridges 20 on the upper layers have no extra space to accommodate user's fingers under the handle 21 to do prying operation. Operation becomes very difficult.

### SUMMARY OF THE INVENTION

Therefore the primary object of the present invention is to solve the aforesaid disadvantages. The invention provides a loading cartridge latch structure that allows the handle to be moved outwards for a selected angle when to release the latched condition to facilitate unloading, and a retaining flange not only providing vertical latch function also confining horizontal movement to achieve optimal loading and unloading functions. In main feature of the invention is a latch structure located in the computer host that has a passage and a latch trough communicating with each other. The latch trough is larger than the latch section of the loading cartridge and forms a latch position and a release position. On the latch position, the handle is in a latched condition through the anchor structure of the loading cartridge, and the latch section is engaged on the latch position to anchor the loading cartridge on an installation object. On the release position, the handle is released from the latched condition on the anchor structure, and the latch section is on the release position to allow the handle to be moved at a release angle to facilitate removing of the loading cartridge.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of conventional loading cartridges in an installed condition.

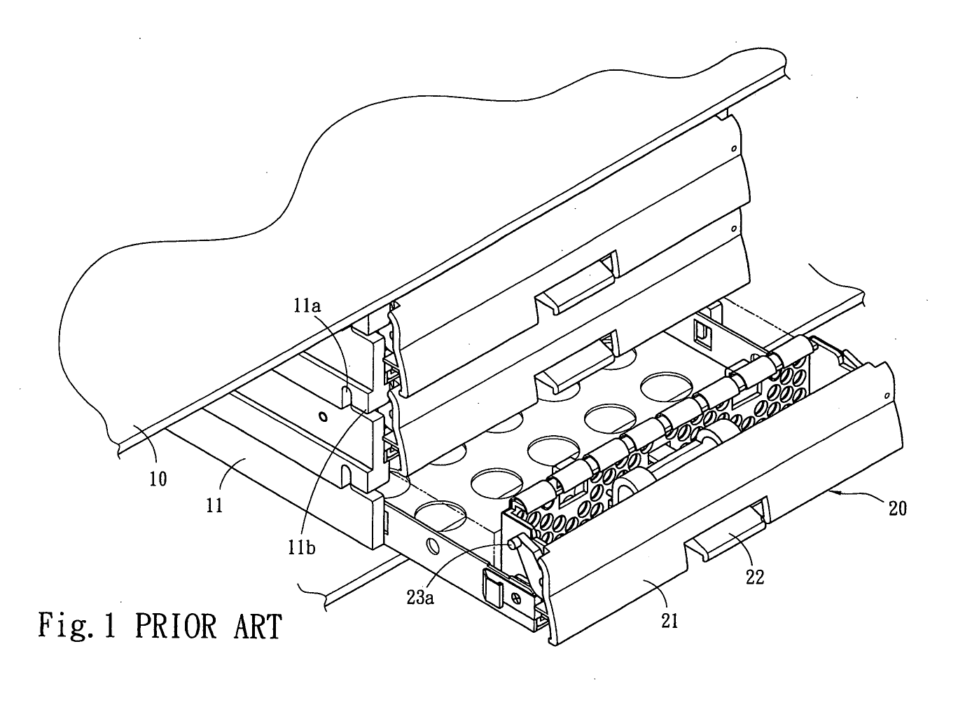

FIG. 2 is a fragmentary side view of a conventional loading cartridge in an installed condition.

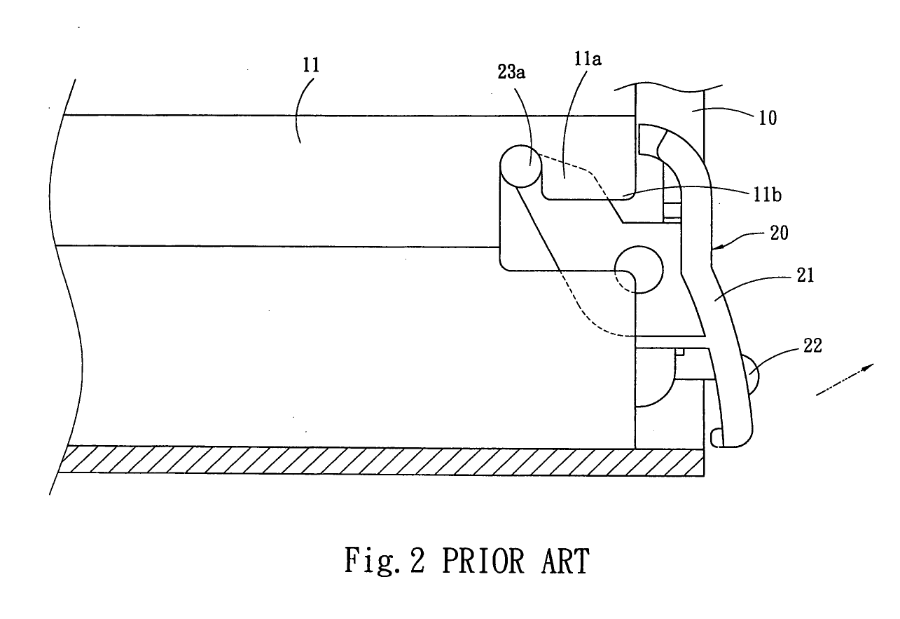

FIG. 3 is a perspective view of loading cartridges of the invention in an installed condition.

FIG. 4 is a perspective view of the partition of the invention.

FIG. 5 is a fragmentary enlarged view of the partition of the invention.

FIGS. 6A, 6B and 6C are schematic views of the loading cartridge of the invention in operating conditions.

### DETAILED DESCRIPTION OF THE PREFERRED EMBODIMENT

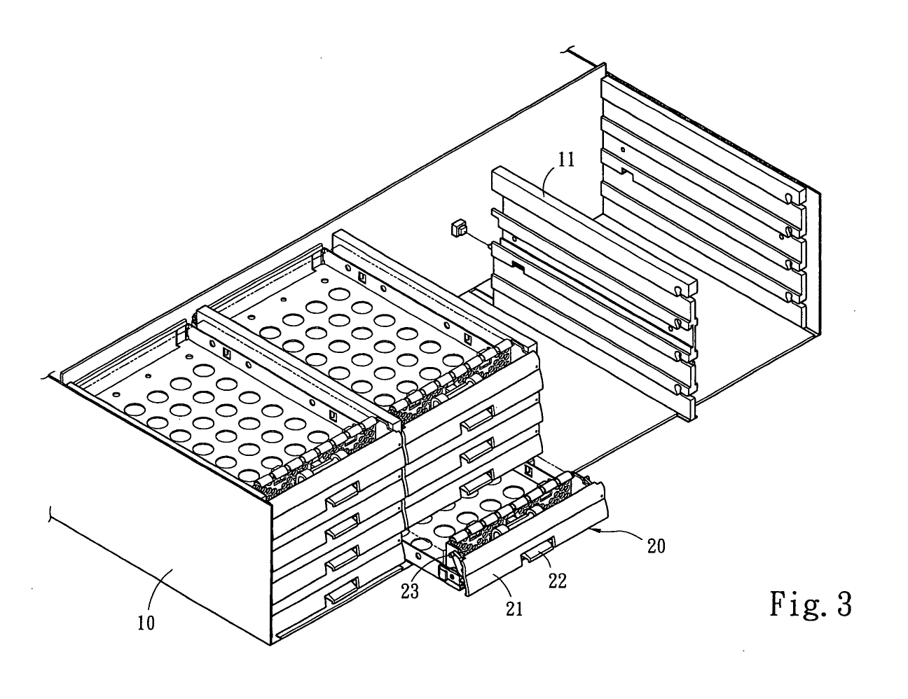

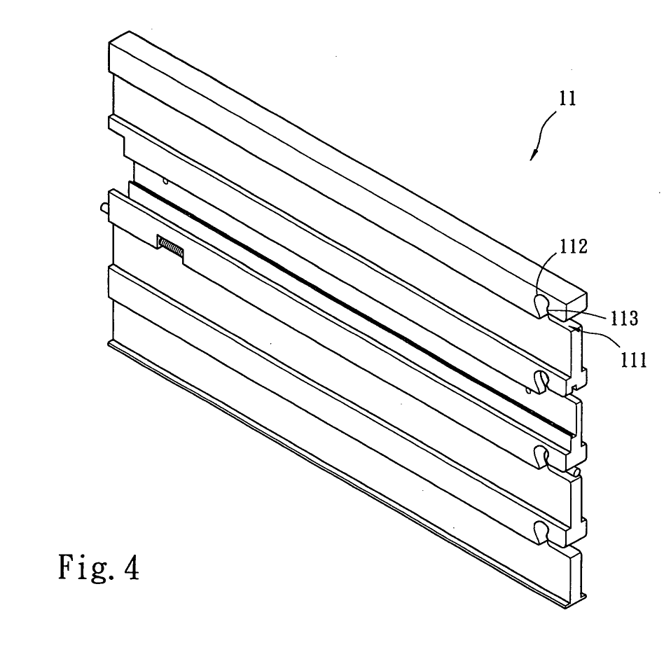

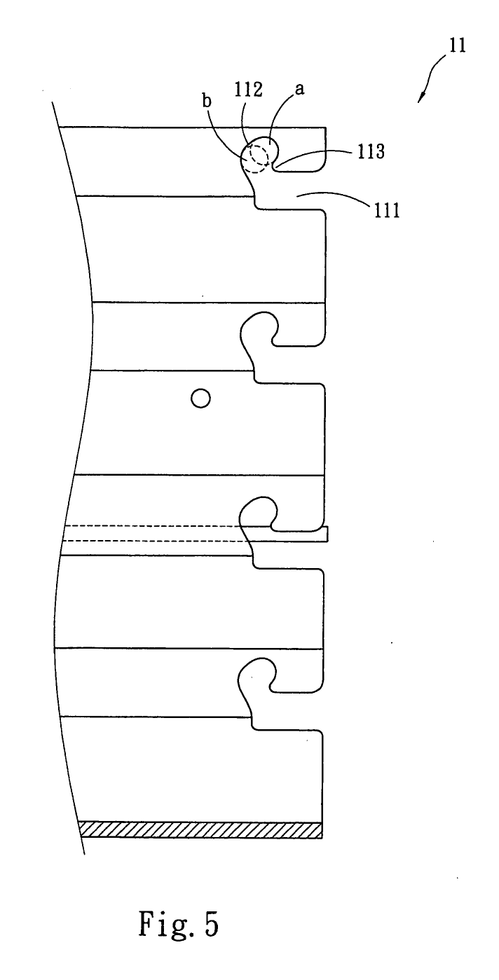

Please refer to FIGS. 3, 4 and 5 for a latch structure located in a computer host 10 to anchor a loading cartridge 20. The computer host 10 has partitions 11 to define space for installing the loading cartridge 20. The latch structure is located in the partition 11 or two side walls of the computer host 10. The loading cartridge 20 has a handle 21 on the front end with latch sections 23 on two sides and an anchor structure 22 (the loading cartridge 20 is not the main focus of the invention, this application incorporates the loading cartridge 20 in the application Ser. No. 10/755,467 previously submitted by the applicant as an example for explanation). The latch structure includes a passage 112 and a latch trough 111 that communicate with each other, and a retaining flange 113 located between the passage 112 and the latch trough 111. The latch trough 111 is larger than the latch section 23 and forms a latch position a and a release position b. On the latch position a, the handle 21 is in a latched condition through the anchor structure 22, and the latch section 23 is coupled on the latch position a to anchor the loading cartridge 20 on an installation object. On the release position b, the handle 21 disengages the latched condition of the anchor structure 22, and the latch section 23 is moved to the release position b to allow the handle 21 to form a release angle relative loading cartridge 20 to facilitate removing.

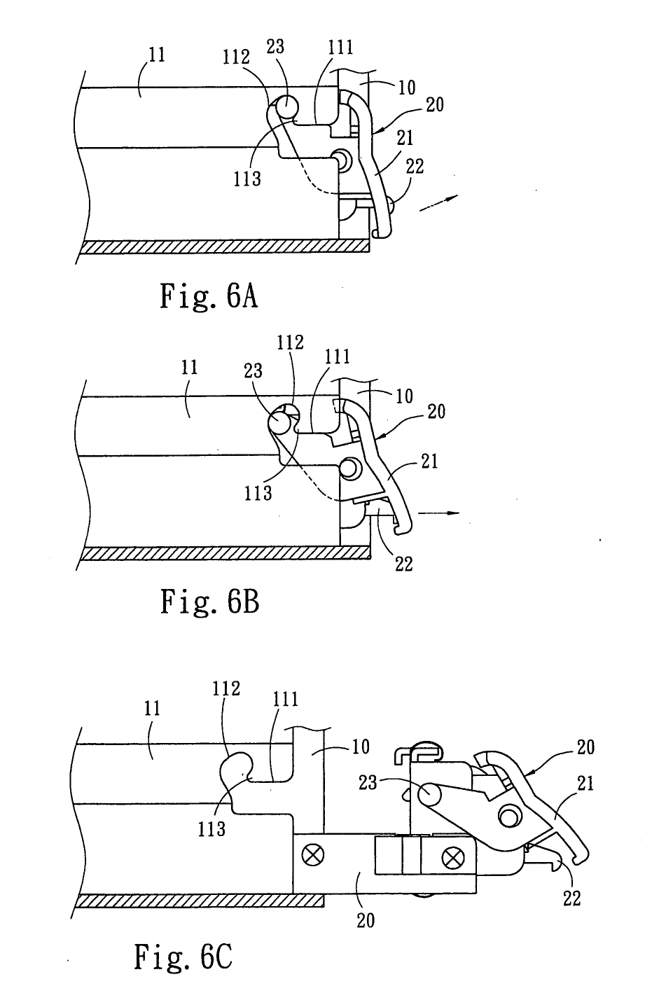

Refer to FIGS. 6A, 6B and 6C for the invention in operating conditions. When the loading cartridge 20 is housed in the installation space of the computer host 10, the handle 21 is in a latched condition on the computer host 10 through the anchor structure 22, and the latch section 23 of the loading cartridge 20 is engaged with the latch trough 111 on the latch position a to be confined by the retaining flange 113 to form a secure anchoring effect.

To remove the loading cartridge 20, applying a force on the anchor structure 22 to release the latched condition. The latch section 23 moves to the release position b, and the handle 21 moves to a release angle relative to the computer host 10 as shown in FIG. 6C, then user can move out the loading cartridge 20 horizontally. The invention may be operated single-handed. It does not have the space constraint when adopted on stacked loading cartridges 20. The loading cartridge 20, whether located on the upper layers or lower layers, can be removed conveniently through the handle 21.

1. A loading cartridge latch structure located in a computer host to anchor a loading cartridge which has a handle on a front end, latch sections on two sides of the handle and an anchor structure, comprising a passage and a latch trough communicating with each other, the latch trough being larger than the latch section to form a latch position and a release position; on the latch position the handle forming a latched condition through the anchor structure and the latch section being located on the latch position to anchor the loading cartridge on an installation object; on the release position the handle being released from latched condition through the anchor structure and the latch section being located on the release position to allow the handle to be moved to a release angle to facilitate removing of the loading cartridge.

2. The loading cartridge latch structure of claim 1, wherein the computer host has partitions to define installation space for housing the loading cartridge, the latch structure being located in the partition.

3. The loading cartridge latch structure of claim 1 further having a retaining flange between the passage and the latch trough.
